(19) United States
(12) Patent Application Publication
(10) Pub. No.: US 2017/0212755 A1
(43) Pub. Date: Jul. 27, 2017

(54) SYSTEM AND METHOD FOR COMPUTING A CRITICALITY METRIC OF A UNIT OF SOURCE CODE

(71) Applicant: HCL Technologies Limited, Noida (IN)

(72) Inventors: Rajesh Babu SURAPARAJU, Chennai (IN); Lavanya KALAISELVAN, Chennai (IN); Priyadharshini BRAHMANAYAGAM, Chennai (IN)

(21) Appl. No.: 15/399,023

(22) Filed: Jan. 5, 2017

(30) Foreign Application Priority Data
Jan. 22, 2016 (IN) 201611002549

(51) Int. Cl. G06F 9/44

(52) U.S. Cl. CPC G06F 8/75; G06F 8/71

(57) ABSTRACT

The present subject matter discloses system and method for computing criticality metric of a unit of source code in software program. The system includes determining module, applying module, and computing module. The determining module determines a logical criticality of the unit of source code, based on one or more factors associated with the unit of source code, by using a natural language processing (NLP) algorithm. Further, the applying module may apply a Bayesian network model on plurality of parameters, including the logical criticality, in order to assign weight to each of the plurality of parameters, and to determine level of dependency between each parameter and at least one other parameter of the plurality of parameters. Further, the computing module computes a criticality metric of the unit of source code based on the weight and the level of dependency associated to each parameter.

### CROSS-REFERENCE TO RELATED APPLICATIONS AND PRIORITY

The present application claims priority from Indian Patent Application No. 201611002549, filed on Jan. 22, 2016, the entirety of which is hereby incorporated by reference.

### TECHNICAL FIELD

The present subject matter described herein generally relates to a method and a system for determining a criticality metric of a unit of source code in a software program.

### BACKGROUND

Software testing or software maintenance is one of a phase in a software development life cycle (SDLC). When a change request arises for changing or updating a particular unit of source code present in a software program, software engineers (developers/testers/software professionals) either experienced or novice may not have a complete understanding of the impact caused by changing/modifying the unit of source code. The unit of source code may be a method or a procedure or a function or any particular class defined in the software program for a specific purpose.

To get the complete view of the unit of source code, the software engineers generally have to refer various documents and files related to that unit of source code. Moreover, the software engineers may also need to contact peers, or experienced peers who were previously involved in the development of that software program to understand the criticality of the unit of source code and the impact it has on the functionality of the application. All the aforementioned factors divert the software engineer's attention from actual work of updating or testing the unit of source code. Also, these factors leave the software engineer or any other person, working on the unit of source code, in an uncertain state of mind i.e., how critical that unit of source code is and what will be the impact on the software program if the unit of source code is modified. This typically results in over-analysis of the code and consequently loss of time and effort or on the corollary, result in under-analysis leading to degradation of the quality of the application.

### SUMMARY

This summary is provided to introduce aspects related to systems and methods for computing a criticality metric of a unit of source code in a software program, which are further described below in the detailed description. This summary is not intended to limit the scope of the subject matter.

In one implementation, a system for computing a criticality metric of a unit of source code in a software program is disclosed. The system includes a processor and a memory coupled to the processor. The processor may execute a plurality of modules stored in the memory. The plurality of modules may include a determining module, an applying module, and a computing module. The determining module may determine a logical criticality of a unit of source code, based on one or more factors associated with the unit of source code, by using a natural language processing (NLP) algorithms. Further, the applying module may apply a Bayesian network model on a plurality of parameters associated with the unit of source code, including the logical criticality, in order to assign a weight to each of the plurality of parameters and to determine a level of dependency between each parameter and at least one other parameter of the plurality of parameters. Further, the computing module may compute a criticality metric of the unit of source code based on the weight and the level of dependency associated to each parameter.

In another implementation, a method for computing a criticality metric of a unit of source code in a software program is disclosed. The method may include determining, by a processor, a logical criticality of a unit of source code, based on one or more factors associated with the unit of source code, by using a natural language processing (NLP) algorithms. Further, the method may include a step of applying, by the processor, a Bayesian network model on a plurality of parameters associated with the unit of source code, including the logical criticality, in order to assign a weight to each of the plurality of parameters and to determine a level of dependency between each parameter and at least one other parameter of the plurality of parameters. The method may further include a step of computing, by the processor, a criticality metric of the unit of source code based on the weight and the level of dependency associated to each parameter.

Yet in another implementation, a non-transitory computer readable medium embodying a program executable in a computing device for computing a criticality metric of a unit of source code in a software program is disclosed. Further, the program may comprise a program code for determining a logical criticality of a unit of source code, based on one or more factors associated with the unit of source code, by using a natural language processing (NLP) algorithms. The program may further comprise a program code for applying a Bayesian network model on a plurality of parameters associated with the unit of source code, including the logical criticality, in order to assign a weight to each of the plurality of parameters and to determine a level of dependency between each parameter and at least one other parameter of the plurality of parameters. Further, the program may comprise a program code for computing a criticality metric of the unit of source code based on the weight and the level of dependency associated to each parameter.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for computing a criticality metric of a unit of source code in a software program, in accordance with an embodiment of the present subject matter.

FIG. 2 illustrates the system, in accordance with an embodiment of the present subject matter.

FIG. 3 illustrates detail explanation of the system, in accordance with an embodiment of the present subject matter.

FIG. 4 illustrates a method for computing a criticality metric of a unit of source code in a software program, in accordance with an embodiment of the present subject matter.

### DETAILED DESCRIPTION

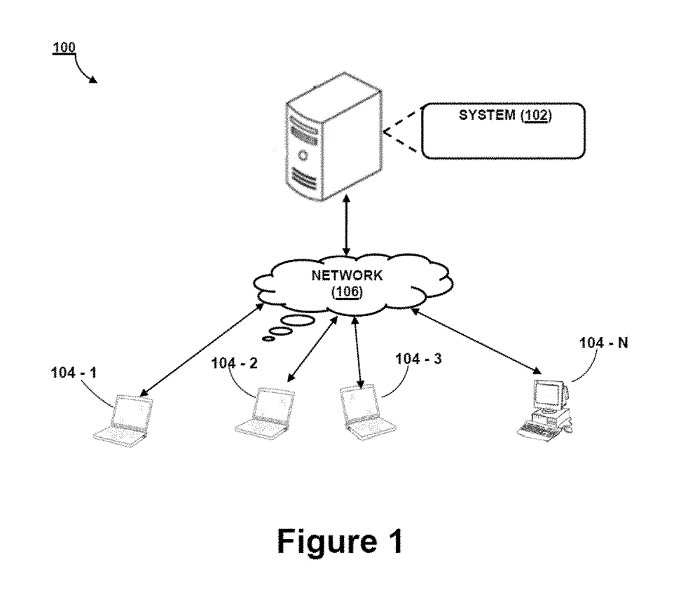

Referring to FIG. 1, a network implementation 100 of system 102 for computing a criticality metric of a unit of source code in a software program is illustrated, in accordance with an embodiment of the present subject matter. Although the present subject matter is explained considering that the system 102 is implemented for computing the criticality metric on a server, it may be understood that the system 102 may also be implemented in a variety of computing systems, such as a laptop computer, a desktop computer, a notebook, a workstation, a mainframe computer, a server, a network server, a tablet, a mobile phone, and the like. In one embodiment, the system 102 may be implemented in a cloud-based environment. It will be understood that the system 102 may be accessed by multiple users through one or more user devices 104-1, 104-2, 104-3, 104-N, collectively referred to as user 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 106 may include a variety of network devices, including routers, bridges, servers, computing devices, storage devices, and the like.

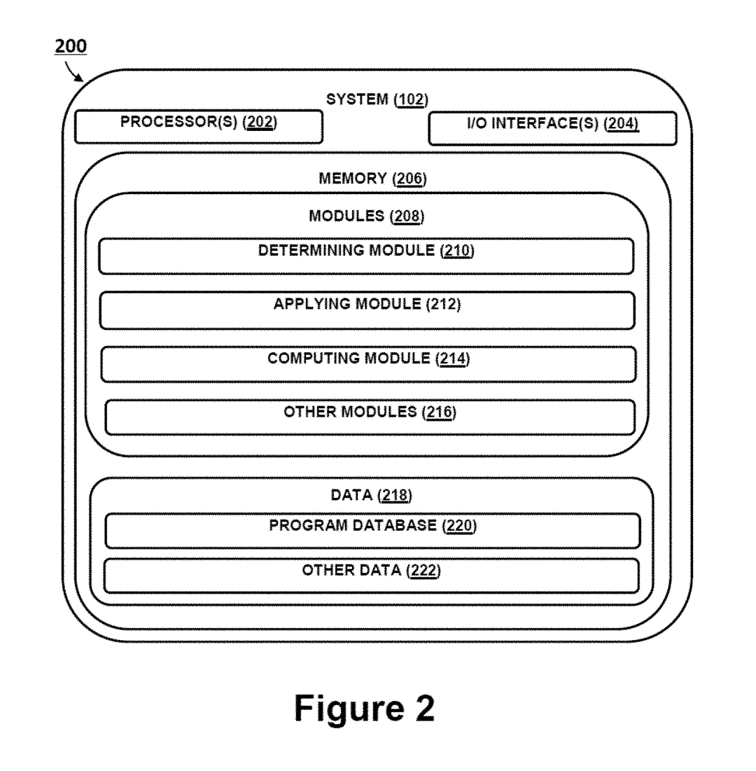

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions or modules stored in the memory 206.

The I/O interface 204 may include a variety of software and hardware interfaces, for example, a web interface, a graphical user interface, and the like. The I/O interface 204 may allow the system 102 to interact with a user directly or through the user devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, a compact disks (CDs), digital versatile disc or digital video disc (DVDs) and magnetic tapes. The memory 206 may include modules 208 and data 218.

The modules 208 include routines, programs, objects, components, data structures, etc., which perform particular tasks or implement particular abstract data types. In one implementation, the modules 208 may include a determining module 210, an applying module 212, a computing module 214, and other modules 216. The other modules 216 may include programs or coded instructions that supplement applications and functions of the system 102.

The data 218, amongst other things, serves as a repository for storing data processed, received, and generated by one or more of the modules 208. The data 218 may also include a program database 220, and other data 222. Further, each of the aforementioned modules is explained in detail in subsequent paragraphs of the specification.

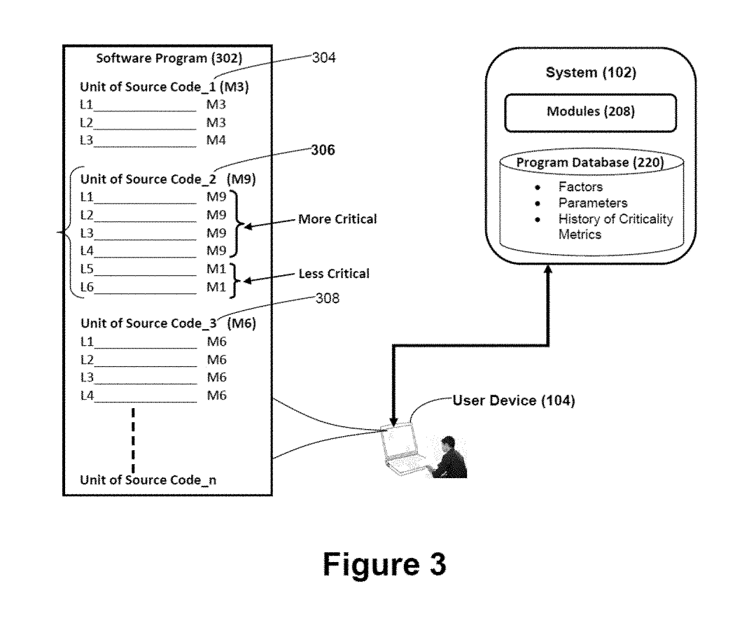

Referring now to FIG. 3, FIG. 3 depicts a detailed explanation of the system, in accordance with an embodiment of the present subject matter. In general, the software applications or the software programs consist of methods, functions, procedures, classes defined in one or more programming languages. When the software program executes, it performs a specific purpose. However, to keep the software program synced with its specific purpose, the software program is required to be regularly updated or maintained or tested. Further, this regular update or maintenance is also based on requirements of clients or due to some specific need. Highly skilled professionals like software engineers/programmers perform the task of updating or testing of the software programs. But, the software engineer working on the software program may not always be the same person who has developed that particular software program, and therefore, he/she may not understand the criticality of the methods, the functions, the procedures, or the classes defined in that software program. This leads to confusion, in the mind of the software engineer (or any other skilled person) working on the software program, about the impact caused by modifying any method, function, the procedure, or the class defined in the software program. Hereinafter, the aforementioned methods, functions, procedures, and classes may be collectively referred as “unit of source code”.

Thus, to address above discussed concern, the present subject matter discloses the system 102 and method for determining the criticality of the unit of source code present in the software program. According to embodiments of present disclosure, the system 102 computes a single metric i.e., a criticality metric which indicates the criticality of the unit of source code. The purpose of the present disclosure is to provide a complete visibility to the user (i.e., the software engineer/software programmer/software tester) about the software program before making any changes in the unit of source code. The criticality metric computed is numeric in nature which gives a fair idea to the user about the criticality of the unit of source code present in the software program.

With each of the unit of source code, there may be several factors and parameters involved. These factors may comprise keywords, function names, calculation logic or any other details based on which an importance of the unit of source code may be determined. The factors are stored in the program database 220 of the system 102. Based on the factors involved with the unit of source code, the determining module 210 of the system 102 may determine a logical criticality of the unit of source code by using one or more natural language processing (NLP) algorithms like Open NLP algorithms, Snowball, MALLET and the like. According to embodiments, the NLP algorithm may be customized for determining the logical criticality. For example, if the unit of source code comprises an important function name (i.e., factor), then the determining module 210 may determine its logical criticality accordingly. Similarly, if the unit of source code comprises some calculation logic written as a formulae (i.e., factor), then also the determining module 210 determines the logical criticality accordingly. Thus, by using the customized NLP algorithms for semantically interpreting source code, the influence of the aforementioned factors on the unit of source code may be evaluated. Further, based on such evaluation, the logical criticality of the unit of source code may be determined. Further, the logical criticality along with the parameters is further used by the system 102 for computing the criticality metric which is explained in subsequent paragraphs of the specification.

Since the purpose of the present disclosure is to provide complete visibility of the software program to the user, one or more possible parameters associated with the unit of source code are considered by the system 102. These parameters considered may include, but not limited to, functional dependencies, type of code, and complexity of code which are associated with the unit of source code. The aforementioned parameters are further stored in the program database 220 of the system 102. Further, the complete view of these parameters is shown in below table 1.

TABLE 1
The parameters and their details associated with the unit of source code.

| Functional | Complexity | | |
|---|---|---|---|
| dependencies | of Code | Type of Code | |
| i. Requirement/ | i. Cyclomatic | Executable | Non-executable |
| Use-case | complexity | Code:- | Code:- |
| priority | ii. Code | i. Declarative | i. Comments |
| ii. Defects | dependencies/ | (Class, | ii. Class, method, |
| identified | call graphs | Method, | variable |
| iii. Test Efforts | | variable . . . ) | declaration |
| iv. Execution load | | ii. Structural | comments |
| | | (If/for | iii. Logical |
| | | structural | explanation |
| | | statements . . . ) | comments |
| | | iii. Log statements | iv. Flow related |
| | | iv. Import | comments |
| | | v. Return | |
| | | statements | |
| | | vi. Error handling | |
| | | vii. Design Pattern | |

From the above table, the details of the parameters associated with the unit of source code can be seen. Thus, in next step, the applying module 212 of the system 102 may apply a Bayesian network model on the aforementioned parameters associated with the unit of source code, including the logical criticality to assign a weight to each of the aforementioned parameters. Further, a level of dependency between each parameter and at least one other parameter of the aforementioned of parameters is also determined. Now, the weight and the level of dependency gives more detailed information to the system 102 about the unit of source code present in the software program. Based on the weight and the level of dependency, formulae may be derived by the system 102 for computing the criticality metric. Thus, the computing module 214 of the system 102 computes the criticality metric of the unit of source code based on the weight and the level of dependency associated to each parameter.

The criticality metric computed for the different units of source code of a software program 302 is shown in the FIG. 3. According to an embodiment of present disclosure, the criticality metric may be computed on scale of M1 to M10, wherein M1 indicates least critical and M10 indicates most critical. However, it must be understood to a person skilled in art that there may be other scales which may be considered by the system 102 for indicating the criticalness of the unit of source code.

In FIG. 3, it can be seen that the software program 302 has 3 units of source code i.e., Unit of Source code_1 (304), Unit of Source code_2 (306), and Unit of Source code_3 (308). For the Unit of Source code_1 (304), the criticality metric is computed as M3 which gives an indication to the user that the Unit of Source code_1 (304) is not so critical. It can be further observed from FIG. 3 that the criticality metric is not only computed for the unit of source code, but it is also computed at a granular level i.e., for each line of code present in the unit of source code. Considering another unit of source code (i.e., Unit of Source code_2 (306)) in the software program 302, the criticality metric is computed is M9, however, the criticality metric computed for the lines of code (i.e., L1, L2, L3, L4, L5 and L6) is different. This way, the system 102 gives more transparency to the user regarding the criticality of the unit of source code of the software program.

Suppose, the Unit of Source code_2 (306) is software method written for calculating a simple interest for a banking application, it becomes important to display the criticalness of that method to the user. In this case, criticality metric displayed for the lines of code L1 to L4 is “M9” and for the lines of code L5 to L6 is “M1”, which shows that the lines of code L1 to L4 are more critical in nature than the lines of code L1 and L2. This may happen because lines of code L1 to L4 may comprise a calculation logic for calculating the simple interest, whereas, the lines of code L5 and L6 may simply has print command for giving a print of a statement. Thus, the criticality metric computed at the granular level which gives more insightful information to the user regarding the criticalness of the unit of source code. The user becomes more careful while working on such unit of source code. Further, if the user does any changes in the unit of source code of the software program, the system 102 updates the criticality metric of that unit of source code in real-time. Further, the history of the criticality metric computed for the unit of source code is also stored in the program database 302 of the system 102.

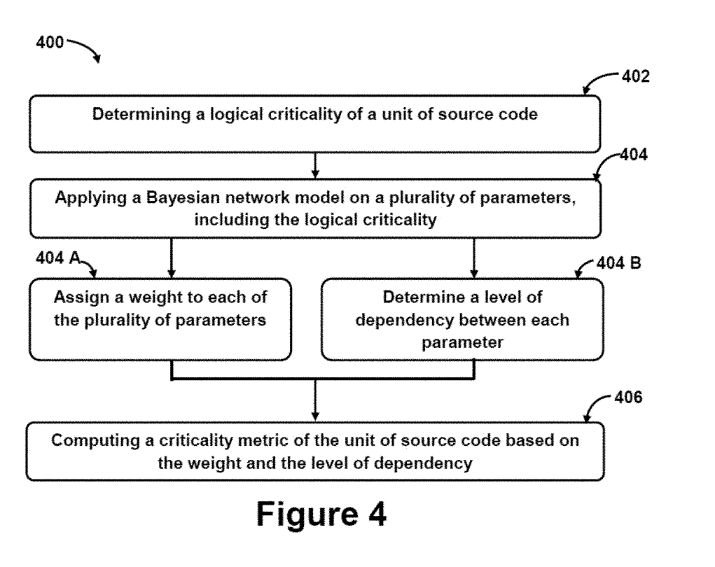

Referring now to FIG. 4, the method of computing a criticality metric of a unit of source code in a software program is shown, in accordance with an embodiment of the present subject matter. The method 400 may be described in the general context of computer executable instructions. Generally, computer executable instructions can include routines, programs, objects, components, data structures, procedures, modules, functions, etc., that perform particular functions or implement particular abstract data types. The method 400 may also be practiced in a distributed computing environment where functions are performed by remote processing devices that are linked through a communications network. In a distributed computing environment, computer executable instructions may be located in both local and remote computer storage media, including memory storage devices.

The order in which the method 400 is described is not intended to be construed as a limitation, and any number of the described method blocks can be combined in any order to implement the method 400 or alternate methods. Additionally, individual blocks may be deleted from the method 400 without departing from the spirit and scope of the subject matter described herein. Furthermore, the method can be implemented in any suitable hardware, software, firmware, or combination thereof. However, for ease of explanation, in the embodiments described below, the method 400 may be considered to be implemented in the above described system 102.

At block 402, a logical criticality of a unit of source code may be determined, based on one or more factors associated with the unit of source code, by using a natural language processing (NLP) algorithm.

At block 404, a Bayesian network model may be applied on a plurality of parameters, including the logical criticality in order to perform the steps shown in block 404A and 404B.

At block 404A, a weight may be assigned to each of the plurality of parameters.

At block 404B, a level of dependency may be determined between each parameter and at least one other parameter of the plurality of parameters.

At block 406, a criticality metric of the unit of source code may be computed based on the weight and the level of dependency associated to each parameter.

Although implementations for methods and systems for computing the criticality metric have been described in language specific to structural features and/or methods, it is to be understood that the appended claims are not necessarily limited to the specific features or methods described. Rather, the specific features and methods are disclosed as examples of implementations for computing the criticality metric of the unit of source code in the software program.

We claim:

1. A method for computing a criticality metric of a unit of source code in a software program, the method comprising:
determining, by a processor, a logical criticality of a unit of source code, based on one or more factors associated with the unit of source code, by using a natural language processing (NLP) algorithm;
applying, by the processor, a Bayesian network model on a plurality of parameters associated with the unit of source code, including the logical criticality, in order to
assign a weight to each of the plurality of parameters, and
determine a level of dependency between each parameter and at least one other parameter of the plurality of parameters; and
computing, by the processor, a criticality metric of the unit of source code based on the weight and the level of dependency associated to each parameter.

2. The method of claim 1, wherein the unit of source code comprises at least one of a software line, software function, a software procedure, a software method, and a software class.

3. The method of claim 1, wherein the one or more factors comprise at least one of keywords, function name, and calculation logic present in the unit of source code.

4. The method of claim 1, wherein the plurality of parameters further comprises functional dependencies, type of code, and complexity of code.

5. The method of claim 1, wherein the criticality metric is updated in real-time when a change is detected in the unit of source code.

6. A system for computing a criticality metric of a unit of source code in a software program, and wherein the system comprises:
a processor;
a memory coupled with the processor, wherein the processor executes a plurality of modules stored in the memory, and wherein the plurality of modules comprises:
a determining module to determine a logical criticality of a unit of source code, based on one or more factors associated with the unit of source code, by using a natural language processing (NLP) algorithm;
an applying module to apply a Bayesian network model on a plurality of parameters associated with the unit of source code, including the logical criticality, in order to
assign a weight to each of the plurality of parameters, and
determine a level of dependency between each parameter and at least one other parameter of the plurality of parameters; and
a computing module to compute a criticality metric of the unit of source code based on the weight and the level of dependency associated to each parameter.

7. The system of claim 6, wherein the unit of source code comprises at least one of a software line, a software function, a software procedure, a software method, and a software class.

8. The system of claim 6, wherein the one or more factors comprise at least one of keywords, function name, and calculation logic present in the unit of source code.

9. The system of claim 6, wherein the plurality of parameters further comprises functional dependencies, type of code, and complexity of code.

10. The system of claim 6, wherein the criticality metric is updated in a real-time when a change is detected in the unit of source code.

11. A non-transitory computer readable medium embodying a program executable in a computing device for computing a criticality metric of a unit of source code in a software program, the program comprising:
a program code for determining a logical criticality of a unit of source code, based on one or more factors associated with the unit of source code, by using a natural language processing (NLP) algorithm;
a program code for applying a Bayesian network model on a plurality of parameters associated with the unit of source code, including the logical criticality, in order to
assign a weight to each of the plurality of parameters, and
determine a level of dependency between each parameter and at least one other parameter of the plurality of parameters; and
a program code for computing a criticality metric of the unit of source code based on the weight and the level of dependency associated to each parameter.
